(19) United States
(12) Patent Application Publication
(10) Pub. No.: US 2023/0115084 A1
(43) Pub. Date: Apr. 13, 2023

(54) REAL-TIME SYSTEMS AND METHODS FOR IDENTIFYING A CERTIFIED REPAIR FACILITY

(71) Applicant: State Farm Mutual Automobile Insurance Company, Bloomington, IL (US)

(72) Inventor: Jaclyn P. Byers, Bloomington, IL (US)

(21) Appl. No.: 18/045,251

(22) Filed: Oct. 10, 2022

Related U.S. Application Data
(60) Provisional application No. 63/254,424, filed on Oct. 11, 2021.

(51) Int. Cl. G06Q 10/00; G06Q 40/08

(52) U.S. Cl. CPC G06Q 10/20; G06Q 40/08

(57) ABSTRACT

A certified repair self-service (“CRSS”) computer system for enabling a policyholder of an automobile insurance policy to identify a certified repair facility in real-time after submission of an initial loss claim is provided. The CRSS computer system includes a processor programmed to: (i) retrieve policyholder insurance data; (ii) verify that the policyholder is eligible to receive an insurance vehicle repair; (iii) retrieve a list of select service locations based on the user device location; (iv) retrieve a list of certified repair facilities based on the policyholder insurance data, wherein a certified repair facility is a service location certified for the vehicle of the policyholder; (v) cause to be displayed on a user device an interface that enables the policyholder to select a certified repair facility in real-time; and (vi) transmit the certified rental facility selection and at least some of the policyholder insurance data to the selected certified repair facility.

### CROSS-REFERENCE TO RELATED APPLICATIONS

This application claim priority to U.S. Provisional Patent Application No. 63/254,424, filed Oct. 11, 2021, entitled “REAL-TIME SYSTEMS AND METHODS FOR IDENTIFYING A CERTIFIED REPAIR FACILITY,” the entire contents and disclosure of which are hereby incorporated herein by reference in its entirety.

### FIELD OF USE

The present disclosure relates to identifying a certified repair facility in real-time, and more particularly, to a network-based real-time system and method for enabling a policyholder of an automobile insurance policy to identify a certified repair facility.

### BACKGROUND

An automobile insurance policyholder may report a loss of vehicle use with the policyholder's insurer when his or her vehicle has been damaged. For example, vehicle damage may occur due to a vehicular accident or a hit-and-run accident. Most often, a policyholder needs to have his or her vehicle repaired. This may require the policyholder to locate and travel to a repair facility. Furthermore, in some case the repair facility may or may not have the capacity and the needed parts, materials, and/or equipment to repair the vehicle. Thus, the policyholder may have to take the vehicle elsewhere to get it repaired. There exists a need for a policyholder who has filed a loss with their insurer to identify a repair facility in real-time that accepts the insurance policy of the policyholder and that is certified for the policyholder's vehicle needs.

### BRIEF SUMMARY

The present embodiments may relate to real-time systems and methods for identifying a certified repair facility. The system may include a certified repair self-service (“CRSS”) computer system, one or more insurance network computer devices, one or more user devices potentially associated with at least one camera, and/or one or more repair facility computer devices. The CRSS computer system may be associated with an insurance network, or may be separate from an insurance network but be in communication with an insurance network.

The CRSS computer system may be configured to: (i) query an insurance provider database to retrieve policyholder insurance data from the insurance provider database using a claim identifier and a policyholder identifier; (ii) verify that the policyholder is eligible to receive an insurance vehicle repair; (iii) retrieve, from a plurality of vendor computing devices, a list of select service locations, based on the user device location, wherein a select service location is a pre-authorized repair facility; (iv) retrieve, from the plurality of vendor computing devices, a list of certified repair facilities, based on the policyholder insurance data, wherein a certified repair facility is a select service location certified for the vehicle of the policyholder; (v) cause to be displayed on a user device associated with the policyholder an interface that is configured to enable the policyholder to select a certified repair facility; and (vi) transmit the certified repair facility selection and at least some of the policyholder insurance data to the selected certified repair facility. The computer system may include additional, less, or alternate actions, including those discussed elsewhere herein.

In one aspect, a certified repair self-service (“CRSS”) computer system configured to enable a policyholder to identify a certified repair facility may be provided. In some exemplary embodiments, the CRSS computer system may include a processor in communication with a memory. The processor may be programmed to: (i) query a database using the representation of the claim identifier and the policyholder identifier, to retrieve policyholder data; (ii) verify that the policyholder is eligible to receive an insurance vehicle repair by performing an eligibility check using the claim identifier and the policyholder identifier, wherein the eligibility check includes applying eligibility rules stored in the memory to determine policyholder eligibility; (iii) retrieve, from a plurality of vendor computing devices, a list of select service locations, based on the user device location; (iv) retrieve, from the plurality of vendor computing devices, a list of certified repair facilities, based on the policyholder insurance data; (v) prepopulate a portion of an interface of the certified repair self-service portal using the retrieved policyholder insurance data, for display on the user device; and (vi) in response to receiving certified repair facility input into the interface, transmit the certified repair facility selection and at least some of the policyholder insurance data to the selected certified repair facility. The computer system may include additional, less, or alternate actions, including those discussed elsewhere herein.

In yet another aspect, a method for enabling a policyholder of an automobile insurance policy to identify a certified repair facility in real-time is provided. The method is implemented by a computer system comprising at least one processor in communication with at least one memory. The method includes (a) receiving, from a user device associated with the policyholder, an initial loss claim filed by the policyholder, including a user device location, a vehicle identification number, a point of impact, and a vehicle drivability indication; (b) querying an insurance provider database to retrieve at least some of the policyholder insurance data using (i) a claim identifier associated with the initial loss claim filed by the policyholder, and (ii) a policyholder identifier associated with the policyholder, the insurance provider database associated with an insurance provider providing the automobile insurance policy to the policyholder, (c) verifying that the policyholder is eligible to receive an insurance vehicle repair by performing an eligibility check using the claim identifier and the policyholder identifier, wherein the eligibility check includes applying eligibility rules stored in the memory to determine policyholder eligibility, (d) retrieving, from a plurality of repair facility computing devices, a list of select service locations, based on the user device location, wherein a select service location is a pre-authorized repair facility, (e) retrieving, from the plurality of repair facility computing devices, a list of certified repair facilities, based on the policyholder insurance data, wherein a certified repair facility is a select service location certified for the vehicle of the policyholder, (f) prepopulating a policyholder information portion of an interface of a certified repair self-service portal using the retrieved policyholder insurance data, the interface of the certified repair self-service portal configured to enable the policyholder to select a certified repair facility in real-time from a plurality of repair facilities associated with the plurality of repair facility computing devices, (g) causing the pre-populated interface of the certified repair self-service portal to be displayed on the user device, (h) receiving, via the user device, a selection of a certified repair facility, (i) causing to be displayed on the user device an option to confirm the certified repair facility selection, (j) transmitting the certified repair facility selection and at least some of the policyholder insurance data to the selected certified repair facility. The method may include additional, less, or alternate actions, including those discussed elsewhere herein.

In yet another aspect, at least one non-transitory computer-readable storage media having computer-executable instructions embodied thereon may be provided. When executed by at least one processor, the computer-executable instructions cause the processor to: (a) receive, from a user device associated with a policyholder, an initial loss claim filed by the policyholder, including a user device location, a vehicle identification number, a point of impact, and a vehicle drivability indication; (b) query an insurance provider database to retrieve at least some of the policyholder insurance data using (i) a claim identifier associated with the initial loss claim filed by the policyholder, and (ii) a policyholder identifier associated with the policyholder, the insurance provider database associated with an insurance provider providing an automobile insurance policy to the policyholder; (c) verify that the policyholder is eligible to receive an insurance vehicle repair by performing an eligibility check using the claim identifier and the policyholder identifier, wherein the eligibility check includes applying eligibility rules stored in memory to determine policyholder eligibility; (d) retrieve, from a plurality of repair facility computing devices, a list of select service locations, based on the user device location, wherein a select service location is a pre-authorized repair facility; (e) retrieve, from the plurality of repair facility computing devices, a list of certified repair facilities, based on the policyholder insurance data, wherein a certified repair facility is a select service location certified for the vehicle of the policyholder; (f) prepopulate a policyholder information portion of an interface of a certified repair self-service portal using the retrieved policyholder insurance data, the interface of the certified repair self-service portal configured to enable the policyholder to select a certified repair facility in real-time from a plurality of repair facilities associated with the plurality of repair facility computing devices; (g) cause the pre-populated interface of the certified repair self-service portal to be displayed on the user device; (h) receive, via the user device, a selection of a certified repair facility; (i) cause to be displayed on the user device an option to confirm the certified repair facility selection; and (j) transmit the certified repair facility selection and at least some of the policyholder insurance data to the selected certified repair facility. The non-transitory computer-readable storage media may include additional, less, or alternate actions, including those discussed elsewhere herein.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of the systems and methods disclosed therein. It should be understood that each Figure depicts an embodiment of a particular aspect of the disclosed systems and methods, and that each of the Figures is intended to accord with a possible embodiment thereof. Further, wherever possible, the following description refers to the reference numerals included in the following Figures, in which features depicted in multiple Figures are designated with consistent reference numerals.

There are shown in the drawings arrangements which are presently discussed, it being understood, however, that the present embodiments are not limited to the precise arrangements and are instrumentalities shown, wherein:

FIG. 1 illustrates a flow chart of an exemplary process of enabling a policyholder to identify a certified repair facility in real-time in accordance with the present disclosure.

FIG. 2 illustrates a flow chart of an exemplary computer-implemented process for one aspect of the process of identifying a certified repair facility in real-time as shown in FIG. 1, in accordance with the present disclosure.

FIG. 3 illustrates a simplified block diagram of an exemplary computer system for implementing the processes shown in FIGS. 1 and 2.

FIG. 4 illustrates an exemplary configuration of a user computer device, in accordance with one embodiment of the present disclosure.

FIG. 5 illustrates an exemplary configuration of a server computer device, in accordance with one embodiment of the present disclosure.

FIG. 6 illustrates a diagram of components of one or more exemplary computing devices that may be used in the system shown in FIG. 3.

The Figures depict preferred embodiments for purposes of illustration only. One skilled in the art will readily recognize from the following discussion that alternative embodiments of the systems and methods illustrated herein may be employed without departing from the principles of the disclosure described herein.

### DETAILED DESCRIPTION OF THE DRAWINGS

The present embodiments may relate to, inter alia, improved real-time systems and methods for identifying a certified repair facility. The systems and methods described herein overcome the deficiencies of other known systems. In one exemplary embodiment, the process may be performed by a certified repair self-service (“CRSS”) computing device. In the exemplary embodiment, the CRSS computing device may be in communication with a user computer device (e.g., a mobile computer device), an insurance network, and one or more repair facilities.

In the exemplary embodiment, the CRSS computing device may retrieve policyholder insurance data from an insurance network using a claim identifier associated with an initial loss claim submission, and a policyholder identifier associated with the policyholder. More specifically, the CRSS computing device retrieves policyholder insurance data specific to an automobile insurance policy held by the policyholder who reports a loss (e.g., files an initial loss claim). In the exemplary embodiment, the CRSS computing device automatically generates a query to retrieve the policy holder information. In some of these embodiments, the CRSS computing device uses the claim identifier as the key value for retrieving the policyholder information.

In the exemplary embodiment, the claim identifier may be associated with an initial loss claim submission (e.g., first notice of loss) filed by the policyholder. The claim identifier may be a claim number generated by the CRSS computing device or another insurance network computing device when the policyholder files a first notice of loss (e.g., FNOL). The policyholder identifier may be a policy number or other policy identifier associated with the policyholder. In the exemplary embodiment, the policyholder may provide the policyholder identifier when filing the FNOL. The policyholder identifier and the claim identifier may be used to retrieve the policyholder's automobile insurance policy as of the date and time the claim identifier is generated. In the exemplary embodiment, the CRSS computing device uses the claim identifier and the policyholder identifier to retrieve the policyholder's vehicle repair coverage as of the date the claim identifier is generated.

In the exemplary embodiment, the CRSS computing device may perform a pre-eligibility check using the information provided by the policyholder in the FNOL. The CRSS computing device provides access to a self-service portal that enables the policyholder to identify a certified repair facility in real-time, within a short period of time of submitting the FNOL. In some embodiments, an insurance network computing device in communication with the CRSS computing device may perform the pre-eligibility check using the information provided by the policyholder in the FNOL. In the exemplary embodiment, the pre-eligibility check improves the functioning of the CRSS computing device by reducing the number of computer resources needed to process claims and policies. More specifically, the pre-eligibility check filters out users that will not pass the more rigorous eligibility check and thus reduces the computer resources needed by removing the need to perform the more computer resource intensive eligibility check. This reduces the computer resources needed overall.

In the exemplary embodiment, the CRSS computing device retrieves the policyholder's vehicle repair coverage as of the date of the reported loss, and displays this information to the policyholder. The policyholder may review the displayed vehicle repair coverage. The policyholder may confirm that he or she understands their vehicle repair coverage and wishes to proceed with the self-service certified repair facility selection process. In the exemplary embodiment, the CRSS computing device receives confirmation from the policyholder, and subsequently performs an eligibility check (e.g., a second check) to verify that the policyholder remains eligible. The CRSS computing device may perform the eligibility check by determining that a pay code (e.g., cause of loss) for the initial loss claim submission (e.g., FNOL) exists (e.g., is open). In the exemplary embodiment, the CRSS computing device may communicate with an accounting system of the insurer to verify that a repair pay code is open for the reported loss. In the exemplary embodiment, the repair pay code enables the insurer to directly make payments to a certified repair facility. The CRSS computing device may use the claim identifier and the policyholder identifier to verify that a pay code is open. In some embodiments, the CRSS computing device may also apply a set of eligibility rules to the information provided by the policyholder in the FNOL. The eligibility rules may be similar to the rules applied by the CRSS computing device during the pre-eligibility check. In the exemplary embodiment, the eligibility also check improves the functioning of the CRSS computing device by reducing the number of computer resources needed to process claims and policies. More specifically, the pre-eligibility check filters out users that are not eligible for repair, thereby removing the need to search for and communicate with remote computer devices associated with those repair facilities. This reduces the number of messages needed, and thus reduces the amount of bandwidth needed. This also reduces the computer resources needed overall.

In the exemplary embodiment, the CRSS computing device may provide an interface to the policyholder. More specifically, an interface is provided by the CRSS computing device, causing the interface to be displayed to a policyholder (on a policyholder computing device) who remains eligible to proceed with the self-service certified repair facility selection process. In the exemplary embodiment, the CRSS computing device may filter a list of repair facilities to only display certified repair facilities. In some embodiments, the CRSS computing device may filter the list of certified repair facilities to only display those that are certified to repair the policyholder's vehicle. This may be based on the make, model, and/or year of the vehicle, which may be determined from the vehicle identification number (VIN) and/or other policyholder information. In some further embodiments, the CRSS computing device may further filter the list of displayed repair facilities to display those facilities that are select service providers who have partnered with the insurer. In some of these embodiments, the select service providers may be ranked at the top of the displayed list of repair providers.

In the exemplary embodiment, the CRSS computing device enables the policyholder to identify certified repair facilities. In some embodiments, the CRSS computing device may enable the policyholder to select a certified repair facility from a list of select service providers who have partnered with the insurer. In these embodiments, the CRSS computing device may query the insurance network to retrieve certified repair facility information provided by the policyholder during the initial loss claim submission process.

In the exemplary embodiment, the CRSS computing device receives a certified repair facility selection from the policyholder via user interface. In some embodiments, the CRSS computing device may prompt the policyholder, via the user interface, to contact the selected certified repair facility to inquire about available vehicle repair.

In the exemplary embodiment, the CRSS computing device may receive, from the policyholder via the user interface, confirmation of a certified repair facility selection. In some embodiments, the CRSS computing device may transmit the certified repair facility selection information and claim information of the policyholder to the selected certified repair facility.

Subsequent to receiving confirmation, the CRSS computing device may provide to the policyholder confirmation information via the user interface, such as a summary of the certified repair facility selection. In the exemplary embodiment, the CRSS computing device may provide, to the policyholder, instructions on how to proceed. In further embodiments, the CRSS computing device may transmit the certified repair facility selection information and claim information, such as the claim identifier to one or more computer devices of the selected certified repair facility. In other embodiments, the CRSS computing device may update the policyholder's claim file to include the certified repair facility selection. The policyholder's claim file may contain information related to the initial loss claim submission. In further embodiments, the CRSS computing device may also generate a file note for a claims handler. In these embodiments, the generated file note may be a message in the policyholder's claim file notifying the claims handler of the certified repair facility selection.

Exemplary technical effects of the systems, methods, and computer-readable media described herein may include, for example: (i) enabling a policyholder to identify a certified repair facility in real-time, within a short period of time of submitting a first notice of loss; (ii) improving the claims process by eliminating the need for the policyholder to repeatedly provide the same information found in the initial claim loss; (iii) providing a rules-based pre-eligibility check to determine whether a policyholder is eligible to access a self-service portal; (iv) automatically retrieving policyholder information (e.g., vehicle repair coverage, initial loss report, accident history to indicate types of accidents for which a certified repair facility has been needed) from a database to facilitate the certified repair facility selection process; (v) providing a rules-based eligibility check upon accessing the self-service portal to verify that a policyholder remains eligible; and (vi) improving efficiency by enabling policyholders to identify a certified repair facility the first time, reducing the chance for possible confusion, miscommunication, and unnecessary travel between repair facilities.

### Exemplary Process for Enabling a Policyholder to Identify a Certified Repair Facility in Real-Time

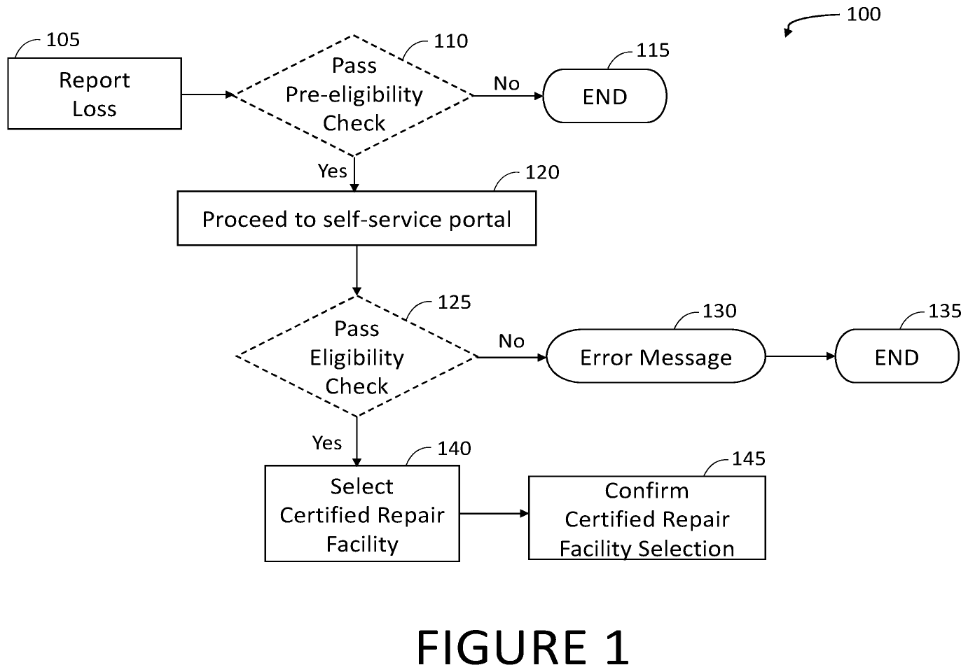

FIG. 1 illustrates a flow chart of an exemplary process 100 of enabling a policyholder to identify a certified repair facility in real-time, in accordance with the present disclosure. In the exemplary embodiment, process 100 is performed by a computer device associated with an insurance provider. In other embodiments, process 100 is performed by a computer device in communication with an insurance provider.

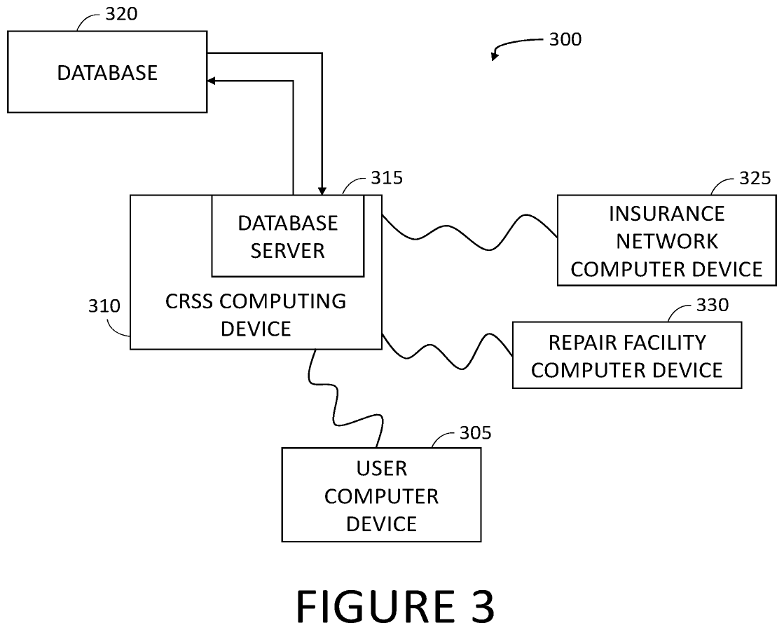

In the exemplary embodiment, a computer device associated with an insurance provider, such as a certified repair self-service (“CRSS”) computing device 310 (shown in FIG. 3), enables a policyholder (not shown) of the insurance provider to report 105 a loss. The policyholder may report 105 the loss by filing an initial loss claim. In the exemplary embodiment, the policyholder utilizes a computer device, such as a mobile computer device, to report 105 the loss. In some embodiments, the policyholder may report 105 the loss by calling their automobile insurance provider via a mobile device. In the exemplary embodiment, the policyholder may utilize an application or website, associated with an insurance provider to report 105 the loss. The loss may be damage to a vehicle due to a vehicular accident (e.g., collision) or a hit-and-run. In other examples, damage may be due to random chance or Mother Nature, such as hail damage, damage from a falling tree limb, or a rock or other object impacting with the vehicle.

In the exemplary embodiment, CRSS computing device 310 (shown in FIG. 3) receives, from the policyholder, identification information such as a policy number, a name of the policyholder (e.g., named insured), or both. CRSS computing device 310 also receives information about the loss from the policyholder. This information may include, but is not limited to, the make and model of the vehicle, the vehicle identification number, the circumstances surrounding damage, pictures or images of the damage, and details concerning the current condition of the vehicle. The vehicle condition details provided may include, but are not limited to, the extent of damage to the vehicle, the point of impact, and any leaking fluids. In the exemplary embodiment, CRSS computing device 310 receives, from the policyholder, an indication as to whether the policyholder plans to repair the vehicle.

In the exemplary embodiment, CRSS computing device 310 is configured to determine if the policyholder passes 110 a pre-eligibility check. The pre-eligibility check may be a rules-based check. Rules may be stored in a database, and applied to policyholder information inputted by the policyholder (e.g., information provided in the initial loss report) along with the policyholder's profile stored within the database (e.g., policyholder's automobile insurance policy, accident history, claims history). CRSS computing device 310 performs a pre-eligibility check (e.g., a first check) to determine if the policyholder is eligible to receive an insurance vehicle repair under the policyholder's automobile insurance policy. CRSS computing device 310 may determine eligibility by querying the database to retrieve the data and applying a set of eligibility rules to the information provided by the policyholder and the retrieved data.

CRSS computing device 310 may utilize models, algorithms, and/or formulas stored within a database to determine eligibility based on the specific circumstances surrounding the policyholder's reported loss. For example, vehicular damage due to the insured's negligence may be assessed differently than vehicular damage due to hail. Eligibility may additionally be based on a variety of factors such as (i) state laws governing the policyholder's automobile insurance provisions, (ii) whether the policyholder has vehicle repair coverage, (iii) whether the reported loss is of the type covered under the policyholder's vehicle repair coverage, (iv) whether a specific provision in the policyholder's insurance policy covers repairs, (v) whether, in a vehicular accident, the other driver is at fault; and (vi) if in a vehicular accident, whether the at-fault driver's property damage coverage will pay for the policyholder's vehicle repair. The policyholder may need to meet one, some, or all of the eligibility rules in order to proceed and receive an insurance vehicle repair on his or her own. In some embodiments, the policyholder may immediately be notified of the results of the pre-eligibility check. In other embodiments, there may be a wait time from when the policyholder reports 105 a loss (e.g., files an initial claim loss) to when the policyholder is notified of the results of the pre-eligibility check. In these embodiments, the wait time may be due to additional information required by CRSS computing device 310 from the policyholder.

In the exemplary embodiment, the pre-eligibility check improves the functioning of the CRSS computing device by reducing the number of computer resources needed to process claims and policies. More specifically, the pre-eligibility check filters out users that will not pass the more rigorous eligibility check and thus reduces the computer resources needed by removing the need to perform the more computer resource intensive eligibility check. This reduces the computer resources needed overall.

If the policyholder does not pass 110 the pre-eligibility check, the policyholder is ineligible to initiate a vehicle repair on his or her own, and the self-service vehicle rental process comes to an end 115. In the exemplary embodiment, if the policyholder passes 110 the pre-eligibility check, CRSS computing device 310 enables the policyholder to proceed 120 to a self-service portal. The self-service portal may be an application, website, or webpage that provides the policyholder with continuing steps for identifying a certified repair facility in real-time. In some embodiments, the self-service portal may be a separate application or website from the one utilized by the policyholder to report 105 the loss. In other embodiments, the self-service portal may be the same application or website as the one utilized by the policyholder to report 105 the loss. In these embodiments, an ineligible policyholder may be denied further access of the application or website. In the exemplary embodiment and in the case where the policyholder passes 110 the pre-eligibility check, CRSS computing device 310 causes the policyholder's computing device to display and execute the self-service portal, which includes a user interface.

In the exemplary embodiment, CRSS computing device 310 connects a specific policyholder to his or her policyholder profile (e.g., information as to the policyholder's automobile insurance policy, accident history, claims history) stored within a database of CRSS computing device 310 such as database 320 through the certified repair self-service portal (shown in FIG. 3). When a policyholder who passes 110 the pre-eligibility check accesses the certified repair self-service portal on his or her user device, CRSS computing device 310 queries the database to retrieve policyholder data. CRSS computing device 310 prepopulates policyholder insurance data on a user device associated with the policyholder. Policyholder insurance data may include the policyholder's automobile insurance policy provisions and claim information (e.g., information associated with the policyholder's claim file and initial loss report). CRSS computing device 310 may transmit a message (e.g., e-mail, text) to the policyholder such that the policyholder may proceed 120 to the self-service portal at a later time. In some embodiments, CRSS computing device 310 may generate and transmit the message to policyholders who pass 110 the pre-eligibility check that the policyholder may proceed 120 to the self-service portal. For example, the policyholder might not consider obtaining receiving a vehicle repair at the time of reporting 105 a loss, but later decides that he or she wants to repair the vehicle.

In the exemplary embodiment, CRSS computing device 310 causes the self-service portal to display the policyholder's auto insurance policy information. The self-service portal may display the policyholder's coverage provisions, such as vehicle repair coverage. In the exemplary embodiment, the policyholder's coverage as of the date and time of the filed claim (e.g., reported 105 loss) are retrieved and displayed. In some embodiments, the self-service portal may also provide an explanation of the policyholder's vehicle repair coverage. In the exemplary embodiment, CRSS computing device 310 also causes the self-service portal to provide an explanation of the repair process to the policyholder. CRSS computing device 310 is also configured to enable the policyholder to confirm that he or she is interested in receiving a vehicle repair. In some embodiments, CRSS computing device 310 may cause the self-service portal to display a confirmation button (e.g., an “I understand” button). In these embodiments, the policyholder clicks the confirmation button to confirm that he or she understands the insurance coverage provisions, and is interested in proceeding with the vehicle repair.

In the exemplary embodiment, CRSS computing device 310 is configured to determine if the policyholder passes 125 another rules-based check (e.g., an eligibility check). CRSS computing device 310 performs the eligibility check (e.g., a second rules-based check) to verify that the policyholder remains eligible for vehicle repair services under the policyholder's automobile insurance policy. For example, the policyholder may report 105 a loss and pass 110 the pre-eligibility check, but delay in initiating a vehicle repair due to circumstances surrounding the loss (e.g., extensive communications between the policyholder's insurance provider and an at-fault driver's insurance provider) or simply due to the policyholder's busy schedule. In another example, a policyholder who had no intentions of receiving a vehicle repair at the time of the pre-eligibility check, may later decide to repair the vehicle. Thus, in the above examples, a time period may elapse from when the policyholder reports 105 the loss (e.g., files an initial loss claim) to when the policyholder proceeds 120 to the self-service portal.

In the exemplary embodiment, the eligibility also check improves the functioning of the CRSS computing device by reducing the number of computer resources needed to process claims and policies. More specifically, the pre-eligibility check filters out users that are not eligible for repair, thereby removing the need to search for and communicate with remote computer devices associated with those repair facilities. This reduces the number of messages needed, and thus reduces the amount of bandwidth needed. This also reduces the computer resources needed overall.

In the exemplary embodiment, CRSS computing device 310 performs the eligibility check by determining if a pay code (e.g., cause of loss) associated with the initial loss claim submission (e.g., reported 105 loss) exists. CRSS computing device 310 may determine if a pay code specific to vehicle repair (e.g., is open) for the reported 105 loss. In the exemplary embodiment, a pay code for the reported 105 loss enables the insurer to make a payment directly to a vehicle repair facility. CRSS computing device 310 may be in communication with a claims accounting system of the insurer. In some embodiments, CRSS computing device 310 may be in communication with a financial system of the insurer to determine if the insurer is authorized to pay the claim (e.g., pay for the vehicle repair). In the exemplary embodiment, CRSS computing device 310 utilizes the retrieved policyholder and claim information to communicate with other insurer computing devices, and determine if a pay code exists for the reported loss. CRSS computing device 310 may perform the eligibility check without additional input from the policyholder.

If a pay code for the initial loss claim submission does not exist (e.g., is not open), the insurer is unable to pay for the claim. A pay code may not exist because of changes to the initial loss claim submission and/or changes to the policyholder's insurance coverage. For example, the initial loss claim submission may be updated to reflect new information that disqualifies the policyholder from receiving a vehicle repair under his or her existing insurance coverage. In some embodiments, if a pay code (e.g., cause of loss) associated with a vehicle repair does not exist, CRSS computing device 310 may systematically open a pay code for the reported 105 loss, and request confirmation from a financial system of the insurer. In these embodiments, if CRSS computing device 310 receives a response from the financial system confirming that the pay code should be open, CRSS computing device 310 may determine that the policyholder passes 125 the eligibility check. In these embodiments, if CRSS computing device receives a response from the financial system denying the pay code (e.g., pay code should not be open), the CRSS computing device 310 may determine that the policyholder does not pass 125 the eligibility check.

In some embodiments, CRSS computing device 310 may also apply a set of eligibility rules in addition to determining if a pay code (e.g., cause of loss) exists. Similar to the pre-eligibility check, CRSS computing device 310 may utilize models, algorithms, and/or formulas to verify eligibility based on the information provided in the policyholder's initial loss claim submission (e.g., reported 105 loss). The eligibility rules applied to the initial loss claim submission may include the same rules as the rules used in the pre-eligibility check. In some embodiments, the eligibility rules may be different from the rules used in the pre-eligibility check. The eligibility rules may be based on factors including (i) state laws governing the policyholder's automobile insurance coverage, (ii) whether the policyholder has vehicle repair coverage, (iii) whether the scope of the policyholder's vehicle repair coverage has changed since the pre-eligibility check, (iv) whether the reported loss has been updated, and (v) whether the reported loss as of the date of the eligibility check is covered under the policyholder's vehicle repair coverage. The policyholder may need to meet one, some, or all of the eligibility rules in order to proceed and receive an insurance vehicle repair on his or her own.

In the exemplary embodiment, CRSS computing device 310 may generate an error message 130 if the policyholder does not pass 125 the eligibility check. The error message 130 may be displayed to the policyholder after he or she confirms interest in receiving a vehicle repair. For example, upon clicking a confirmation button (e.g., an “I understand” button), the policyholder may receive an error message 130 that directs the policyholder to contact his or her claims handler. At this point, the policyholder is ineligible to proceed with selecting a certified repair facility on his or her own, and the self-service certified repair facility selection process comes to an end 135.

If CRSS computing device 310 determines that the policyholder passes 125 the eligibility check, the CRSS computing device 310 may provide the policyholder the ability to select 140 a certified repair facility. In the exemplary embodiment, CRSS computing device 310 displays a list of certified repair facilities from which the policyholder may choose from. The list of certified repair facilities may be stored within a database associated with CRSS computing device 310 such as database 320 (shown in FIG. 3). Certified repair facilities are select service locations, which are repair facilities that are pre-authorized by the insurance provider to perform repair work, that have the capacity to repair the policyholder's vehicle, based on the materials and parts needed to repair the vehicle (based on the vehicle identification number), the extent of structural or engine damage to the vehicle (based on the point of impact), and the needed repair equipment. In some embodiments, only the vehicle identification number and the point of impact will be needed to identify a certified repair facility. In the exemplary embodiment, these repair facilities have preexisting relationships with the insurance provider. In some embodiments, the insurance provider has a certification program that it applies to repair facilities to determine whether or not the repair facility qualifies to be a select service location and a certified repair facility. In the exemplary embodiment, CRSS computing device 310 displays the certified repair facilities on a map. In other embodiments, CRSS computing device 310 displays the certified repair facilities in a list.

In the exemplary embodiment, the CRSS computing device 310 may filter a list of repair facilities to only display certified repair facilities. In some embodiments, the CRSS computing device 310 may filter the list of certified repair facilities to only display those that are certified to repair the policyholder's vehicle. This may be based on the make, model, and/or year of the vehicle, which may be determined from the vehicle identification number (VIN) and/or other policyholder information. In some further embodiments, the CRSS computing device 310 may further filter the list of displayed repair facilities to display those facilities that are select service providers who have partnered with the insurer. In some of these embodiments, the select service providers may be ranked at the top of the displayed list of repair providers.

In the exemplary embodiment, CRSS computing device 310 searches one or more databases to determine whether the repair facility is a select service location. As described above, select service locations are repair facilities with a pre-existing relationship with the insurance provider, where the insurance provider has pre-authorized the repair facility to perform covered repair on vehicles. In the exemplary embodiment, CRSS computing device 310 determines whether the select service location is a certified repair facility. As described above, certified repair facilities are select service locations that have the capacity to repair the policyholder's vehicle, based on the materials and parts needed to repair the vehicle (based on the vehicle identification number), the extent of structural or engine damage to the vehicle (based on the point of impact), and the needed repair equipment. If CRSS computing device 310 determines that the repair facility is a certified repair facility, CRSS computing device 310 transfer the information about the loss provided by the user to the repair facility. In some embodiments, only the vehicle identification number and the point of impact will be needed to identify a certified repair facility. In the exemplary embodiment, CRSS computing device 310 transmits the information about the loss and the user to the repair facility computer device 330.

In the exemplary embodiment, the policyholder uses a user interface to select 140 a certified repair facility from the list. CRSS computing device 310 may retrieve available certified repair facility information through Application Programming Interface (API) calls to the selected certified repair facility.

In the exemplary embodiment, CRSS computing device 310 may enable the policyholder to confirm 145 the certified repair facility selection. CRSS computing device 310 may enable the policyholder to modify the certified repair facility selection at any point in the self-service process prior to receiving certified repair facility selection confirmation from the policyholder. After receiving confirmation, CRSS computing device 310 may provide, via the user interface, confirmation information such as certified repair facility selection information (e.g., business address, business hours, contact number), a confirmation number, and instructions on how to proceed. Subsequent to receiving confirmation from the policyholder, CRSS computing device 310 may transmit the certified repair facility selection information and claim information, such as the claim identifier to one or more computer devices of the selected certified repair facility. Once the selected certified repair facility receives the necessary information from CRSS computing device 310, the selected certified repair facility may contact the policyholder to confirm receipt of the certified repair facility selection. In some embodiments, CRSS computing device 310 may enable the policyholder to modify (e.g., update) the certified repair facility selection after the policyholder confirms 145 the selection. In these embodiments, CRSS computing device 310 may require the policyholder to confirm 145 the updated certified repair facility selection. In these embodiments, CRSS computing device 310 may subsequently transmit the updated certified repair facility selection to the selected certified repair facility.

### Exemplary Computer-Implemented Real-Time Method for Identifying a Certified Repair Facility

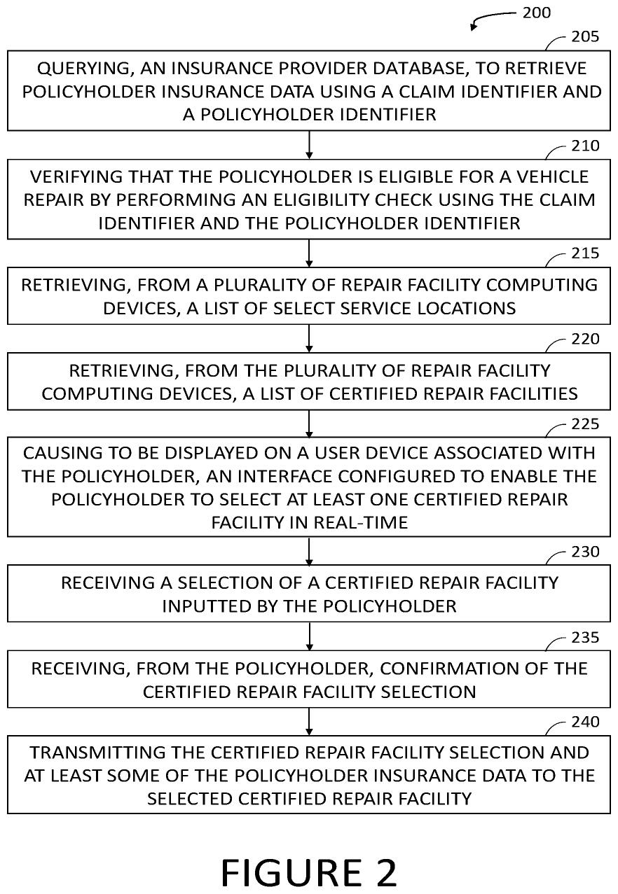

FIG. 2 illustrates a flow chart of an exemplary computer implemented process 200 for one aspect of process 100, namely identifying a certified repair facility in real-time as shown in FIG. 1. More specifically, process 200 shows the steps that occur after a policyholder passes 110 the pre-eligibility check (shown in FIG. 1). Process 200 may be implemented by a computing device, for example certified repair self-service (“CRSS”) computing device 310 (shown in FIG. 3). In the exemplary embodiment, CRSS computing device 310 may be in communication with a user computer device 305 (shown in FIG. 3), such as a mobile computer device, one or more insurance network computer devices 325 (shown in FIG. 3), and one or more repair facilities computer devices 330 (shown in FIG. 3).

In the exemplary embodiment, process 200 may include querying 205 an insurance provider database to retrieve policyholder insurance data using a claim identifier and a policyholder identifier. The insurance provider database may be associated with an insurance provider providing the automobile insurance policy to the policyholder. In the exemplary embodiment, the CRSS computing device 310 automatically generates the query to the database to retrieve the policyholder insurance data. The policyholder insurance data may be stored in a database associated with CRSS computing device 310 such as database 320 (shown in FIG. 3). The claim identifier may be associated with an initial loss claim submission (e.g., first notice of loss) filed by the policyholder (step 105, shown in FIG. 1). The claim identifier may be a claim number generated by CRSS computing device 310 or another insurance network 325 computing device when the policyholder reports 105 the claim (shown in FIG. 1) by filing a first notice of loss (e.g., FNOL). In some embodiments, the query may use the claim identifier as the key value when querying the database 320. The policyholder identifier may be a policy number associated with the policyholder. The policyholder identifier and the claim identifier may be used to retrieve the policyholder's automobile insurance policy as of the date and time the claim identifier is generated.

Process 200 may also include verifying 210 that the policyholder is eligible to receive an insurance vehicle repair by performing an eligibility check (FIG. 1). The eligibility check may be performed using the claim identifier and the policyholder identifier. The claim identifier and policyholder identifier may be used to retrieve policyholder insurance data, such as information associated with (i) the initial loss claim submission and (ii) the policyholder who reported 105 the loss (FIG. 1). In some embodiments, the policyholder insurance data is retrieved from a plurality of databases 320, where the CRSS computing device 310 generates a plurality of queries for the plurality of databases 320. The CRSS computing device 310 queries each of the pertinent databases 310 to retrieve the needed policyholder insurance data. The eligibility check may include applying eligibility rules stored in the memory to determine policyholder eligibility. Additionally or alternatively, the eligibility check may include determining if a pay code (e.g., cause of loss) for the initial loss claim submission has been generated and stored within the memory (e.g., cause of loss is open). CRSS computing device 310 may communicate with an accounting system of the insurer to check that a pay code associated with vehicle repair exists for the reported 105 loss (FIG. 1).

In some embodiments, if the pay code does not exist (e.g., is not open), CRSS computing device 310 may systematically generate a repair pay code for the reported 105 loss, and query the accounting system of the insurer. In these embodiments, CRSS computing device 310 may receive a response from the accounting system approving the systematically opened pay code. Based on the received response, CRSS computing device 310 may determine that the policyholder remains eligible, and complete the verification process. In further embodiments, CRSS computing device 310 may perform the eligibility check by applying a set of eligibility rules to the information provided in the first notice of loss (e.g., initial loss claim submission). In these embodiments, CRSS computing device 310 may apply the set of eligibility rules in addition to determining that a repair pay code associated with the first notice of loss exists. The eligibility rules may be the same or similar to the rules applied in the pre-eligibility check.

Process 200 may also include retrieving 215 a list of select service locations from a plurality of repair facility computing devices. The list of select service locations may be stored within a database associated with CRSS computing device 310 such as database 320 (shown in FIG. 3). Select service locations are repair facilities that are pre-authorized by the insurance provider to perform repair work.

Process 200 may also include retrieving 220 a list of certified repair facilities from a plurality of repair facility computing devices. The list of certified repair facilities may be stored within a database associated with CRSS computing device 310 such as database 320 (shown in FIG. 3). Certified repair facilities are select service locations that have the capacity to repair the policyholder's vehicle, based on the materials and parts needed to repair the vehicle (based on the vehicle identification number), the extent of structural or engine damage to the vehicle (based on the point of impact), and the needed repair equipment. In some embodiments, only the vehicle identification number and the point of impact will be needed to identify a certified repair facility.

In the exemplary embodiment, the CRSS computing device 310 may filter a list of repair facilities to only display certified repair facilities. In some embodiments, the CRSS computing device 310 may filter the list of certified repair facilities to only display those that are certified to repair the policyholder's vehicle. This may be based on the make, model, and/or year of the vehicle, which may be determined from the vehicle identification number (VIN) and/or other policyholder information. In some further embodiments, the CRSS computing device 310 may further filter the list of displayed repair facilities to display those facilities that are select service providers who have partnered with the insurer. In some of these embodiments, the select service providers may be ranked at the top of the displayed list of repair providers.

In addition, process 200 may further include causing 225 to be displayed on a user device associated with the policyholder, a user interface configured to enable the policyholder to identify at least one certified repair facility applicable to the policyholder in real-time. The user interface may be prepopulated with at least some of the policyholder insurance data, and linked to a subset of repair facility data stored within the memory. The subset of repair facility data may be based on the policyholder's particular geographical location, zip code, and/or address (e.g., repair facility address, policyholder home address). The subset of repair facility data may include data as to select service locations partnered with the policyholder's insurance provider (e.g., locations, addresses, business hours, and phone numbers). The subset of repair facility data may also include data as to the certified repair facilities, based on the repair facility's capacity to repair the policyholder's vehicle (e.g., the vehicle materials and parts needed for the repair, extent of structural or engine damage, and needed repair equipment). CRSS computing device 310 may retrieve 215, via one or more databases, a list of select service locations based on the facility information provided by one or more databases. In addition, CRSS computing device 310 may retrieve 220, via one or more databases, a list of certified repair facilities based on the facility information provided by one or more databases. In further embodiments, CRSS computing device 310 may provide limited information on vehicle repair availability at the selected certified repair facility. In these embodiments, CRSS computing device 310 may provide contact information (e.g., phone number, email) of the selected certified repair facility, and instruct the policyholder to directly inquire the selected certified repair facility as to availabilities. Additionally or alternatively, CRSS computing device 310 may prompt the selected certified repair facility to contact the policyholder and provide direct information as to vehicle repair availability.

In addition, process 200 may also include receiving 230, from the policyholder via the user interface, a certified repair facility selection. The transmitted policyholder information may include information such as, but not limited to, the policyholder's policy number, the policyholder's insurance coverage (e.g., rental coverage), and the claim identifier associated with the initial loss claim (e.g., first notice of loss).

Process 200 may also include receiving 235, from the policyholder via the user interface, confirmation of a certified repair facility selection. Subsequent to receiving 235 confirmation from the policyholder, CRSS computing device 310 may transmit 240 the certified repair facility selection and policyholder information to one or more computer devices of the selected certified repair facility. The transmitted policyholder information may include information such as, but not limited to, the policyholder's policy number, the policyholder's insurance coverage (e.g., repair coverage), and the claim identifier associated with the initial loss claim (e.g., first notice of loss). Subsequent to receiving 235 confirmation, CRSS computing device 310 may provide the policyholder a confirmation number and instruct the policyholder to wait for the selected certified repair facility to contact the policyholder.

### Exemplary Computer Network

FIG. 3 depicts a simplified block diagram of an exemplary computer system 300 for implementing process 100 shown in FIG. 1. In the exemplary embodiment, computer system 300 may be used for enabling a policyholder of an automobile insurance policy to identify a certified repair facility in real-time. As described below in more detail, a certified repair self-service (“CRSS”) computing device 310 may be configured to (i) query an insurance provider database to retrieve policyholder insurance data using a claim identifier associated with an initial loss claim submission, and a policyholder identifier associated with the policyholder, the insurance provider database associated with an insurance provider providing the automobile insurance policy to the policyholder; (ii) verify that the policyholder is eligible to receive an insurance vehicle repair by performing an eligibility check using the claim identifier and the policyholder identifier, wherein the eligibility check includes applying eligibility rules stored in the memory to determine policyholder eligibility; (iii) retrieve a list of select service locations from a plurality of repair facility computing devices; (iv) retrieve a list of certified repair facilities from the plurality of repair facility computing devices; (v) cause to be displayed on a user device associated with the policyholder an interface that is prepopulated with at least some of the policyholder insurance data and linked to a subset of certified repair facility data stored within the memory, the interface configured to enable the policyholder to select at least one certified repair facility applicable to the policyholder; (vi) receive a selection of a certified repair facility inputted by the policyholder via the user device; and/or (vii) receive, from the policyholder, confirmation of the certified repair facility selection.

In the exemplary embodiment, user computer devices 305 are computers that include a web browser or a software application, which enables user computer devices 305 to access remote computer devices, such as CRSS computing device 310 and insurance network computer devices 325, using the Internet or other network. More specifically, user computer devices 305 may be communicatively coupled to the Internet through many interfaces including, but not limited to, at least one of a network, such as the Internet, a local area network (LAN), a wide area network (WAN), or an integrated services digital network (ISDN), a dial-up-connection, a digital subscriber line (DSL), a cellular phone connection, and a cable modem. User computer devices 305 may be any device capable of accessing the Internet including, but not limited to, a desktop computer, a laptop computer, a personal digital assistant (PDA), a cellular phone, a smartphone, a tablet, a phablet, wearable electronics, smart watch, or other web-based connectable equipment or mobile devices.

A database server 315 may be communicatively coupled to a database 320 that stores data. In one embodiment, database 320 may include the eligibility rules, select service locations, certified repair facilities, repair facility information, and vehicle information. In the exemplary embodiment, database 320 may be stored remotely from CRSS computing device 310. In some embodiments, database 320 may be decentralized. In the exemplary embodiment, the policyholder may access database 320 via user computer device 305 by logging onto CRSS computing device 310, as described herein.

CRSS computing device 310 may be communicatively coupled with one or more user computer devices 305. In some embodiments, CRSS computing device 310 may be associated with, or is part of a computer network associated with an insurance provider, or in communication with insurance network computer devices 325. In other embodiments, CRSS computing device 310 may be associated with a third party and is merely in communication with the insurance network computer devices 325. More specifically, CRSS computing device 310 is communicatively coupled to the Internet through many interfaces including, but not limited to, at least one of a network, such as the Internet, a local area network (LAN), a wide area network (WAN), or an integrated services digital network (ISDN), a dial-up-connection, a digital subscriber line (DSL), a cellular phone connection, and a cable modem.

CRSS computing device 310 may perform all of the steps of process 100 shown in FIG. 1. In some embodiments, insurance network computer devices 325 may be configured to receive an initial loss claim submission (e.g., policyholder reports 105 loss) and/or determine whether a policyholder passes 110 a pre-eligibility check (both shown in FIG. 1). In these embodiments, insurance network computer devices 325 may be communicatively coupled with CRSS computing device 310 to provide claim information and pre-eligibility check information to CRSS computing device 310.

CRSS computing device 310 may be any device capable of accessing the Internet including, but not limited to, a desktop computer, a laptop computer, a personal digital assistant (PDA), a cellular phone, a smartphone, a tablet, a phablet, wearable electronics, smart watch, or other web-based connectable equipment or mobile devices. In the exemplary embodiment, CRSS computing device 310 hosts an application or website that allows the policyholder to access the functionality described herein. In some further embodiments, user computer device 305 includes an application that facilitates communication with CRSS computing device 310. CRSS computing device 310 is capable of communicating with insurance network computer devices 325, and repair facility computer devices 330 through an application programming interface (API). CRSS computing device 310 may also use APIs to communicate with outside applications, such as, but not limited to, data sources about the damaged vehicle, data sources about driver information concerning the policyholder, access to law enforcement and/or state laws governing automobile insurance policies, and other applications as necessary.

In the exemplary embodiment, insurance network computer devices 325 include one or more computer devices associated with an insurance provider. In the exemplary embodiment, insurance provider is associated with the policyholder and the policyholder has an automobile insurance policy that insures his or her vehicle with insurance provider. In the exemplary embodiment, insurance network computer devices 325 include a web browser or a software application, which enables insurance network computer devices 325 to access remote computer devices, such as CRSS computing device 310 and database server 315, using the Internet or other network. More specifically, insurance network computer devices 325 may be communicatively coupled to the Internet through many interfaces including, but not limited to, at least one of a network, such as the Internet, a local area network (LAN), a wide area network (WAN), or an integrated services digital network (ISDN), a dial-up-connection, a digital subscriber line (DSL), a cellular phone connection, and a cable modem. Insurance network computer devices 325 may be any device capable of accessing the Internet including, but not limited to, a desktop computer, a laptop computer, a personal digital assistant (PDA), a cellular phone, a smartphone, a tablet, a phablet, wearable electronics, smart watch, or other web-based connectable equipment or mobile devices. In some embodiments, insurance network computer devices 325 may access database 320 to update eligibility rules and/or review certified repair facility selection.

In the exemplary embodiment, repair facility computer devices 330 include computer devices associated with certified repair facilities capable of repairing the policyholder's vehicle. More specifically, repair facility computer devices 330 may provide repair facility information such as available locations (e.g., branches) of a repair facility. In the exemplary embodiment, repair facility computer devices 330 include a web browser or a software application, which enables repair facility computer devices 330 to access remote computer devices, such as CRSS computing device 310, using the Internet or other network. More specifically, repair facility computer devices 330 may be communicatively coupled to the Internet through many interfaces including, but not limited to, at least one of a network, such as the Internet, a local area network (LAN), a wide area network (WAN), or an integrated services digital network (ISDN), a dial-up-connection, a digital subscriber line (DSL), a cellular phone connection, and a cable modem. Repair facility computer devices 330 may be any device capable of accessing the Internet including, but not limited to, a desktop computer, a laptop computer, a personal digital assistant (PDA), a cellular phone, a smartphone, a tablet, a phablet, wearable electronics, smart watch, or other web-based connectable equipment or mobile devices. Repair facility computer devices 330 may also include computer devices associated with a selected certified repair facility. Repair facility computing devices 330 may communicate with CRSS computing device 310 during the certified repair facility selection process and provide information such as repair quotes and scheduling information such as the date and time repairs will begin. Repair facility computer devices 330 may communicate with database 320 to retrieve information about the policyholder, information about the loss report, and information related to the certified repair facility selection.

### Exemplary Client Device

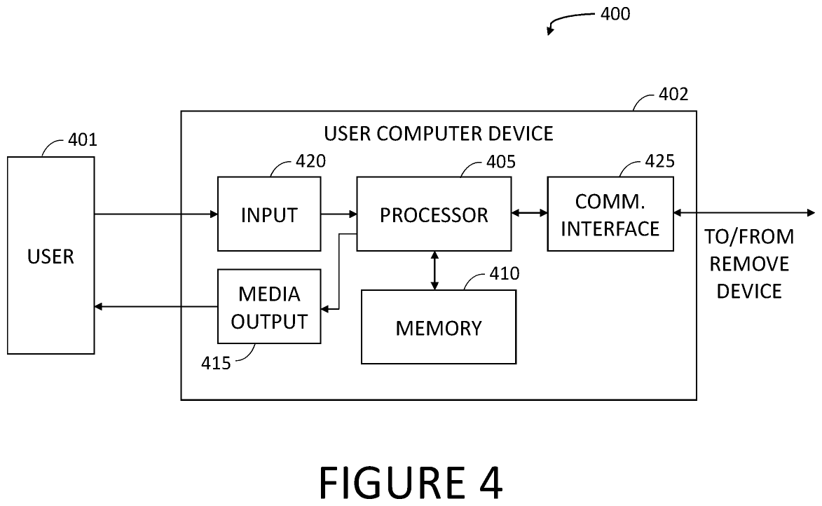

FIG. 4 depicts an exemplary configuration 400 of user computer device 402, in accordance with one embodiment of the present disclosure. In the exemplary embodiment, user computer device 402 may be similar to, or the same as, user computer device 305 (shown in FIG. 3). User computer device 402 may be operated by a user 401. User computer device 402 may include, but is not limited to, user computer devices 305, insurance network computer devices 325, and repair facility computer devices 330 (all shown in FIG. 3). User computer device 402 may include a processor 405 for executing instructions. In some embodiments, executable instructions may be stored in a memory area 410. Processor 405 may include one or more processing units (e.g., in a multi-core configuration). Memory area 410 may be any device allowing information such as executable instructions and/or transaction data to be stored and retrieved. Memory area 410 may include one or more computer readable media.

User computer device 402 may also include at least one media output component 415 for presenting information to user 401. Media output component 415 may be any component capable of conveying information to user 401. In some embodiments, media output component 415 may include an output adapter (not shown) such as a video adapter and/or an audio adapter. An output adapter may be operatively coupled to processor 405 and operatively coupleable to an output device such as a display device (e.g., a cathode ray tube (CRT), liquid crystal display (LCD), light emitting diode (LED) display, or “electronic ink” display) or an audio output device (e.g., a speaker or headphones).

In some embodiments, media output component 415 may be configured to present a graphical user interface (e.g., a web browser and/or a client application) to user 401. A graphical user interface may include, for example, an interface for viewing a list of certified repair facilities, selected certified repair facility location information, estimate costs, and other certified repair facility selection information. In some embodiments, user computer device 402 may include an input device 420 for receiving input from user 401. User 401 may use input device 420 to, without limitation, select and/or enter one or more items of information about certified repair facility selection location and/or repair capacity.

Input device 420 may include, for example, a keyboard, a pointing device, a mouse, a stylus, a touch sensitive panel (e.g., a touch pad or a touch screen), a gyroscope, an accelerometer, a position detector, a biometric input device, and/or an audio input device. A single component such as a touch screen may function as both an output device of media output component 415 and input device 420.

User computer device 402 may also include a communication interface 425, communicatively coupled to a remote device such as CRSS computing device 310 (shown in FIG. 3). Communication interface 425 may include, for example, a wired or wireless network adapter and/or a wireless data transceiver for use with a mobile telecommunications network.

Stored in memory area 410 are, for example, computer readable instructions for providing a user interface to user 401 via media output component 415 and, optionally, receiving and processing input from input device 420. A user interface may include, among other possibilities, a web browser and/or a client application. Web browsers enable users, such as user 401, to display and interact with media and other information typically embedded on a web page or a website from CRSS computing device 310. A client application may allow user 401 to interact with, for example, CRSS computing device 310. For example, instructions may be stored by a cloud service, and the output of the execution of the instructions sent to the media output component 415.

### Exemplary Server Device

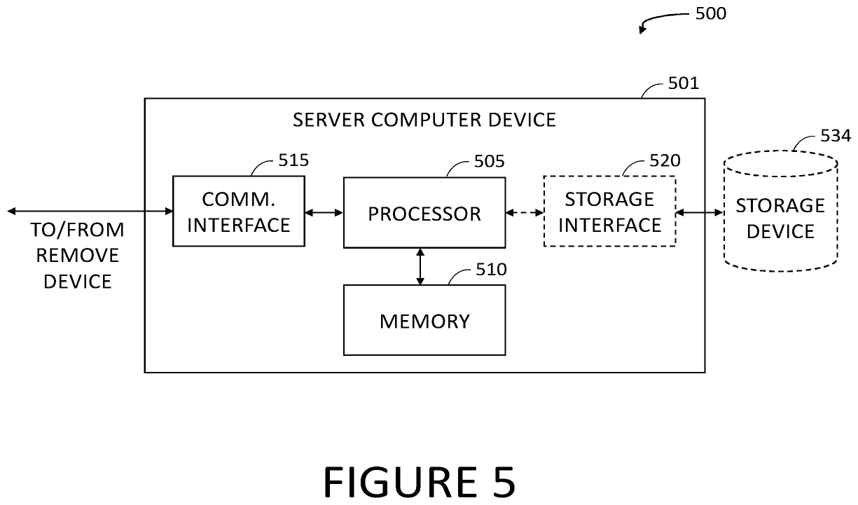

FIG. 5 depicts an exemplary configuration 500 of a server computer device 501, in accordance with one embodiment of the present disclosure. In the exemplary embodiment, server computer device 501 may be similar to, or the same as, CRSS computing device 310 (shown in FIG. 3). Server computer device 501 may include, but is not limited to, CRSS computing device 310, insurance network computer devices 325, repair facility computer devices 330, and database server 315 (all shown in FIG. 3). Server computer device 501 may also include a processor 505 for executing instructions. Instructions may be stored in a memory area 510. Processor 505 may include one or more processing units (e.g., in a multi-core configuration).

Processor 505 may be operatively coupled to a communication interface 515 such that server computer device 501 is capable of communicating with a remote device such as another server computer device 501, CRSS computing device 310, insurance network computer devices 325, repair facility computer devices 330, and user computer devices 305 (all shown in FIG. 3) (for example, using wireless communication or data transmission over one or more radio links or digital communication channels). For example, communication interface 515 may receive requests from user computer devices 305 via the Internet, as illustrated in FIG. 3.

Processor 505 may also be operatively coupled to a storage device 534. Storage device 534 may be any computer-operated hardware suitable for storing and/or retrieving data, such as, but not limited to, data associated with database 320 (shown in FIG. 3). In some embodiments, storage device 534 may be integrated in server computer device 501. For example, server computer device 501 may include one or more hard disk drives as storage device 534.

In other embodiments, storage device 534 may be external to server computer device 501 and may be accessed by a plurality of server computer devices 501. For example, storage device 534 may include a storage area network (SAN), a network attached storage (NAS) system, and/or multiple storage units such as hard disks and/or solid state disks in a redundant array of inexpensive disks (RAID) configuration.

In some embodiments, processor 505 may be operatively coupled to storage device 534 via a storage interface 520. Storage interface 520 may be any component capable of providing processor 505 with access to storage device 534. Storage interface 520 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 505 with access to storage device 534.

Processor 505 may execute computer-executable instructions for implementing aspects of the disclosure. In some embodiments, the processor 505 may be transformed into a special purpose microprocessor by executing computer-executable instructions or by otherwise being programmed. For example, the processor 505 may be programmed with the instruction such as illustrated in FIG. 2.

### Exemplary Computer Device

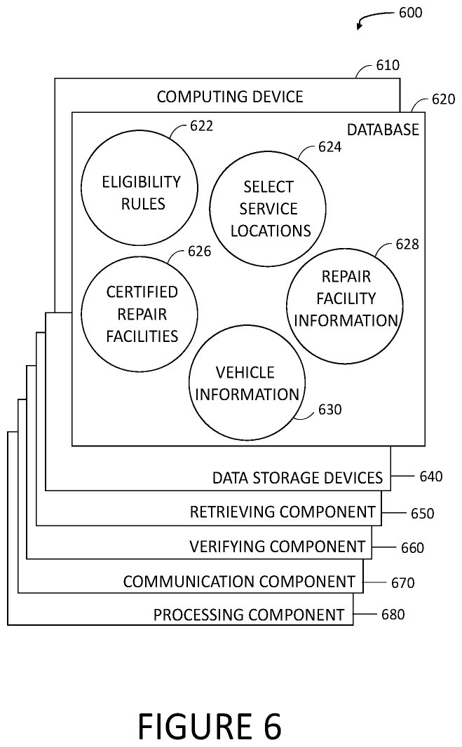

FIG. 6 depicts a diagram 600 of components of one or more exemplary computing devices 610 that may be used in system 300 shown in FIG. 3. In some embodiments, computing device 610 may be similar to CRSS computing device 310. Database 620 may be coupled with several separate components within computing device 610, which perform specific tasks. In this embodiment, database 620 may include the eligibility rules 622, select service locations 624, certified repair facilities 626, repair facility information 628, and vehicle information 630. In some embodiments, database 620 is similar to database 320 (shown in FIG. 3).

Computing device 610 may include the database 620, as well as data storage devices 640. Computing device 610 may also include a retrieving component 650 for retrieving 205 policyholder insurance data from an insurance provider database using a claim identifier and a policyholder identifier (shown in FIG. 2). Computing device 610 may also include a verifying component 660 for verifying 210 that the policyholder is eligible to receive an insurance vehicle repair by performing an eligibility check using the claim identifier and the policyholder identifier (shown in FIG. 2). Computing device 610 may also include a retrieving component 650 for retrieving 215 a list of select service locations from a plurality of repair facility computing devices and for retrieving 220 a list of certified repair facilities from the plurality of repair facility computing devices (shown in FIG. 2). Computing device 610 may further include a communication component 670 for causing 225 to be displayed on a user device associated with the policyholder an interface configured to enable the policyholder to select at least one certified repair facility in real-time, receiving 230 a certified repair facility selection inputted by the policyholder, and receiving 235 a confirmation of the certified repair facility selection from the policyholder (all shown in FIG. 2). A processing component 680 may assist with execution of computer-executable instructions associated with the system.

### Exemplary Embodiments & Functionality

In one aspect, a computer real-time system for identifying a certified repair facility may be provided. The computer system may enable a policyholder of an automobile insurance policy to identify a certified repair facility in real-time subsequent to an initial loss claim submission. The computer system may include a processor in communication with a memory. The processor may be configured or programmed to: (1) query a database 320 to retrieve policyholder insurance data from an insurance provider database using a claim identifier and a policyholder identifier; (2) verify that the policyholder is eligible to receive an insurance vehicle repair by performing an eligibility check using the claim identifier and the policyholder identifier, wherein the eligibility check includes applying eligibility rules stored in the memory to determine policyholder eligibility; (3) retrieve, from a plurality of repair facility computing devices, a list of select service locations, based on the user device location, wherein a select service location is a pre-authorized repair facility; (4) retrieve, from the plurality of repair facility computing devices, a list of certified repair facilities, based on the policyholder insurance data, wherein a certified repair facility is a select service location certified for the vehicle of the policyholder; (5) cause to be displayed on a user device associated with the policyholder an interface that is configured to enable the policyholder to select a certified repair facility in real-time; and (6) transmit the certified rental facility selection and at least some of the policyholder insurance data to the selected certified repair facility.

The computer system may query, one or more databases, to determine a plurality of repair facilities. The computer system may then filter the plurality of repair facilities to generate a subset of repair facilities, wherein the subset of repair facilities are select service locations. The computer system may further filter the plurality of repair facilities to generate a subset of select service locations, wherein the subset of select service locations are certified repair facilities. The computer system may also present, to the user via the user interface, the subset of certified repair facilities and receive, from the user via the user interface, a selection of one of the certified repair facilities.

A further enhancement may be where the policyholder insurance data includes vehicle repair provisions of the automobile insurance policy as of the date and time the claim identifier is generated (e.g., first notice of loss filed).

A further enhancement may be where the computer system verifies that the policyholder is eligible to receive an insurance vehicle repair by determining that a pay code for the initial loss claim submission has been generated and stored within the memory. Another enhancement may be where the computer system transmits the certified repair facility selection to the at least one certified repair facility. The computer system may also transmit at least some of the policyholder insurance data to the at least one certified repair facility.

A further embodiment may be where the computer system updates a claim file of the policyholder to include the certified repair facility selection. The claim file may contain information related to the initial loss claim submission. A further embodiment may be where the computer system generates a file note for a claims handler. The file note may include the certified repair facility selection. A still further embodiment may be where the computer system outputs a certified repair facility selection (e.g., best certified repair facility option) for the policyholder based on the calculation.

A further enhancement may be where the information about the vehicle includes one or more of a make of the vehicle, a model of the vehicle, a vehicle identification number of the vehicle, a year of the vehicle, a point of impact of the vehicle damage, and identification of the user.

### Machine Learning & Other Matters

The computer-implemented methods discussed herein may include additional, less, or alternate actions, including those discussed elsewhere herein. The methods may be implemented via one or more local or remote processors, transceivers, servers, and/or sensors (such as processors, transceivers, servers, and/or sensors mounted on vehicles or mobile devices, or associated with smart infrastructure or remote servers), and/or via computer-executable instructions stored on non-transitory computer-readable media or medium.

Additionally, the computer systems discussed herein may include additional, less, or alternate functionality, including that discussed elsewhere herein. The computer systems discussed herein may include or be implemented via computer-executable instructions stored on non-transitory computer-readable media or medium.

A processor or a processing element may be trained using supervised or unsupervised machine learning, and the machine learning program may employ a neural network, which may be a convolutional neural network, a deep learning neural network, or a combined learning module or program that learns in two or more fields or areas of interest. Machine learning may involve identifying and recognizing patterns in existing data in order to facilitate making predictions for subsequent data. Models may be created based upon example inputs in order to make valid and reliable predictions for novel inputs.

Additionally or alternatively, the machine learning programs may be trained by inputting sample data sets or certain data into the programs, such as images, object statistics and information, historical estimates, accident history that reflects the past need for a certified repair facility, and/or actual repair costs. The machine learning programs may utilize deep learning algorithms that may be primarily focused on pattern recognition, and may be trained after processing multiple examples. The machine learning programs may include Bayesian program learning (BPL), voice recognition and synthesis, image or object recognition, optical character recognition, and/or natural language processing—either individually or in combination. The machine learning programs may also include natural language processing, semantic analysis, automatic reasoning, and/or machine learning.

In supervised machine learning, a processing element may be provided with example inputs and their associated outputs, and may seek to discover a general rule that maps inputs to outputs, so that when subsequent novel inputs are provided the processing element may, based upon the discovered rule, accurately predict the correct output. In unsupervised machine learning, the processing element may be required to find its own structure in unlabeled example inputs. In one embodiment, machine learning techniques may be used to extract data about the object, vehicle, user, damage, needed repairs, costs and/or incident from vehicle data, insurance policies, geolocation data, image data, and/or other data.

Based upon these analyses, the processing element may learn how to identify characteristics and patterns that may then be applied to analyzing image data, model data, and/or other data. For example, the processing element may learn, with the user's permission or affirmative consent, to identify the repair facilities most appropriate for certain types of vehicles and certain types of damages. The processing element may also learn how to identify attributes of different repair facilities that make a user more or less likely to choose that repair facility. This information may be used to determine which repair facilities should be made or qualified as select service locations and certified repair facilities.

### Additional Considerations

As will be appreciated based upon the foregoing specification, the above-described embodiments of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium, such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps”, or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only, and are thus not intended to limit in any way the definition and/or meaning of the term “processor.”

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

In one embodiment, a computer program is provided, and the program is embodied on a computer readable medium. In an exemplary embodiment, the system is executed on a single computer system, without requiring a connection to a sever computer. In a further embodiment, the system is being run in a Windows® environment (Windows is a registered trademark of Microsoft Corporation, Redmond, Wash.). In yet another embodiment, the system is run on a mainframe environment and a UNIX® server environment (UNIX is a registered trademark of X/Open Company Limited located in Reading, Berkshire, United Kingdom). The application is flexible and designed to run in various different environments without compromising any major functionality.

In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes. The present embodiments may enhance the functionality and functioning of computers and/or computer systems.

As used herein, an element or step recited in the singular and preceded by the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

The patent claims at the end of this document are not intended to be construed under 35 U.S.C. § 112(f) unless traditional means-plus-function language is expressly recited, such as “means for” or “step for” language being expressly recited in the claim(s).

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

We claim:

1. A certified repair self-service (“CRSS”) computer system for enabling a policyholder of an automobile insurance policy to identify a certified repair facility in real-time, the CRSS computer system comprising at least one processor in communication with at least one memory, said processor programmed to:
receive, from a user device associated with the policyholder, an initial loss claim filed by the policyholder, including a user device location, a vehicle identification number, a point of impact, and a vehicle drivability indication;
query an insurance provider database to retrieve at least some policyholder insurance data using (i) a claim identifier associated with the initial loss claim filed by the policyholder, and (ii) a policyholder identifier associated with the policyholder, the insurance provider database associated with an insurance provider providing the automobile insurance policy to the policyholder;
verify that the policyholder is eligible to receive an insurance vehicle repair by performing an eligibility check using the claim identifier and the policyholder identifier, wherein the eligibility check includes applying eligibility rules stored in the memory to determine policyholder eligibility;
retrieve, from a plurality of repair facility computing devices, a list of select service locations, based on the user device location, wherein a select service location is a pre-authorized repair facility;
retrieve, from the plurality of repair facility computing devices, a list of certified repair facilities, based on the policyholder insurance data, wherein a certified repair facility is a select service location certified for the vehicle of the policyholder;
prepopulate a policyholder information portion of an interface of a certified repair self-service portal using the retrieved policyholder insurance data, the interface of the certified repair self-service portal configured to enable the policyholder to select a certified repair facility in real-time from a plurality of repair facilities associated with the plurality of repair facility computing devices;
cause the pre-populated interface of the certified repair self-service portal to be displayed on the user device;
receive, via the user device, a selection of a certified repair facility;
cause to be displayed on the user device an option to confirm the certified repair facility selection; and
transmit the certified repair facility selection and at least some of the policyholder insurance data to the selected certified repair facility.

2. The CRSS computer system of claim 1, wherein the policyholder insurance data includes vehicle repair provisions of the automobile insurance policy as of the date and time the claim identifier is generated.

3. The CRSS computer system of claim 1, wherein the policyholder insurance data includes a vehicle material and part list based on the vehicle identification number.

4. The CRSS computer system of claim 1, wherein the policyholder insurance data includes a vehicle structural or engine damage indication based on the point of impact.

5. The CRSS computer system of claim 1, wherein said processor is further programmed to verify that the policyholder is eligible to receive an insurance vehicle repair by determining that a pay code for the initial loss claim has been generated and stored within the memory.

6. The CRSS computer system of claim 1, wherein said processor is further programmed to transmit the certified repair facility selection and at least some of the policyholder insurance data to the selected certified repair facility.

7. The CRSS computer system of claim 1, wherein said processor is further programmed to update a claim file of the policyholder to include the certified repair facility selection, and wherein the claim file contains information associated with the initial loss claim.

8. The CRSS computer system of claim 1, wherein said processor is further programmed to generate a file note for a claims handler, wherein the file note includes the certified repair facility selection.

9. A method for enabling a policyholder of an automobile insurance policy to identify a certified repair facility in real-time, the method is implemented by a computer system comprising at least one processor in communication with at least one memory, the method comprises:
receiving, from a user device associated with the policyholder, an initial loss claim filed by the policyholder, including a user device location, a vehicle identification number, a point of impact, and a vehicle drivability indication;
querying an insurance provider database to retrieve at least some of the policyholder insurance data using (i) a claim identifier associated with the initial loss claim filed by the policyholder, and (ii) a policyholder identifier associated with the policyholder, the insurance provider database associated with an insurance provider providing the automobile insurance policy to the policyholder;
verifying that the policyholder is eligible to receive an insurance vehicle repair by performing an eligibility check using the claim identifier and the policyholder identifier, wherein the eligibility check includes applying eligibility rules stored in the memory to determine policyholder eligibility;
retrieving, from a plurality of repair facility computing devices, a list of select service locations, based on the user device location, wherein a select service location is a pre-authorized repair facility;
retrieving, from the plurality of repair facility computing devices, a list of certified repair facilities, based on the policyholder insurance data, wherein a certified repair facility is a select service location certified for the vehicle of the policyholder;
prepopulating a policyholder information portion of an interface of a certified repair self-service portal using the retrieved policyholder insurance data, the interface of the certified repair self-service portal configured to enable the policyholder to select a certified repair facility in real-time from a plurality of repair facilities associated with the plurality of repair facility computing devices;
causing the pre-populated interface of the certified repair self-service portal to be displayed on the user device;
receiving, via the user device, a selection of a certified repair facility;
causing to be displayed on the user device an option to confirm the certified repair facility selection; and
transmitting the certified repair facility selection and at least some of the policyholder insurance data to the selected certified repair facility.

10. The method of claim 9, wherein the policyholder insurance data includes vehicle repair provisions of the automobile insurance policy as of the date and time the claim identifier is generated.

11. The method of claim 9, wherein the policyholder insurance data includes a vehicle material and part list based on the vehicle identification number.

12. The method of claim 9, wherein the policyholder insurance data includes a vehicle structural or engine damage indication based on the point of impact.

13. The method of claim 9 further comprising verifying that the policyholder is eligible to receive an insurance vehicle repair by determining that a pay code for the initial loss claim has been generated and stored within the memory.

14. The method of claim 9 further comprising transmitting the certified repair facility selection and at least some of the policyholder insurance data to the selected certified repair facility.

15. The method of claim 9 further comprising updating a claim file of the policyholder to include the certified repair facility selection, and wherein the claim file contains information associated with the initial loss claim.

16. The method of claim 9 further comprising generating a file note for a claims handler, wherein the file note includes the certified repair facility selection.

17. At least one non-transitory computer-readable storage media having computer-executable instructions embodied thereon that when executed by at least one processor, the computer-executable instructions cause the processor to:
receive, from a user device associated with a policyholder, an initial loss claim filed by the policyholder, including a user device location, a vehicle identification number, a point of impact, and a vehicle drivability indication;
query an insurance provider database to retrieve at least some of the policyholder insurance data using (i) a claim identifier associated with the initial loss claim filed by the policyholder, and (ii) a policyholder identifier associated with the policyholder, the insurance provider database associated with an insurance provider providing an automobile insurance policy to the policyholder;
verify that the policyholder is eligible to receive an insurance vehicle repair by performing an eligibility check using the claim identifier and the policyholder identifier, wherein the eligibility check includes applying eligibility rules stored in memory to determine policyholder eligibility;
retrieve, from a plurality of repair facility computing devices, a list of select service locations, based on the user device location, wherein a select service location is a pre-authorized repair facility;
retrieve, from the plurality of repair facility computing devices, a list of certified repair facilities, based on the policyholder insurance data, wherein a certified repair facility is a select service location certified for the vehicle of the policyholder;
prepopulate a policyholder information portion of an interface of a certified repair self-service portal using the retrieved policyholder insurance data, the interface of the certified repair self-service portal configured to enable the policyholder to select a certified repair facility in real-time from a plurality of repair facilities associated with the plurality of repair facility computing devices;
cause the pre-populated interface of the certified repair self-service portal to be displayed on the user device;
receive, via the user device, a selection of a certified repair facility;
cause to be displayed on the user device an option to confirm the certified repair facility selection; and
transmit the certified repair facility selection and at least some of the policyholder insurance data to the selected certified repair facility.

18. The non-transitory computer-readable storage media of claim 17, wherein the policyholder insurance data includes vehicle repair provisions of the automobile insurance policy as of the date and time the claim identifier is generated, wherein the policyholder insurance data also includes a vehicle material and part list based on the vehicle identification number, and wherein the policyholder insurance data further includes a vehicle structural or engine damage indication based on the point of impact.

19. The non-transitory computer-readable storage media of claim 17, wherein the computer-executable instructions further cause the processor to verify that the policyholder is eligible to receive an insurance vehicle repair by determining that a pay code for the initial loss claim has been generated and stored within the memory.

20. The non-transitory computer-readable storage media of claim 17, wherein the computer-executable instructions further cause the processor to transmit the certified repair facility selection and at least some of the policyholder insurance data to the selected certified repair facility.
